(19) United States
(12) Patent Application Publication
(10) Pub. No.: US 2003/0037152 A1
(43) Pub. Date: Feb. 20, 2003

(54) Double interfaced storage communication network card with a communication protocol device

(75) Inventors: Wen-Tsung Liu, Hsin Tien City (TW); Chia-Li Chen, Hsin Tien City (TW); Mi-Chang Chen, Hsin Tien City (TW)

Correspondence Address: BACON & THOMAS, PLLC, 625 SLATERS LANE, FOURTH FLOOR, ALEXANDRIA, VA, 22314

(73) Assignee: Carry Computer Eng. Co., Ltd., Taipei (TW)

(21) Appl. No.: 09/929,353

(22) Filed: Aug. 15, 2001

(51) Int. Cl. G06F 15/16; G06F 15/173

(52) U.S. Cl. 709/230

(57) ABSTRACT

The present invention provides a double interfaced storage communication network card with a communication protocol device, more specifically, a double interfaced integral device has a communicating transmission protocol interface and a storage communication network card interface; the said storage communication network card includes all of the peripheral products corresponding with the regulations of the portable computer cards as well as the compact flash cards and is disposed with the communication protocol device of the USB or the 1394 regulation; a micro control chip automatically detects, judges and supports the interfaces of the said two kinds of devices to directly interface the central process unit (CPU) system without going through an intermediate products, such as a card reader, thereby significantly enhances the facilitation of interfacing and connecting between all of the peripheral equipment products corresponding with the regulation of the storage communication network card and the CPU system.

### BACKGROUND OF THE INVENTION

1) Field of the Invention

The present invention relating to a double interfaced storage communication network card with a communication protocol device aims to enable all the peripheral equipment products corresponding with the regulation of the storage communication network card to directly interface the central process unit (CPU) system without the reading of a card reader as an intermediate equipment so as to enhance the development of the future application domain.

2) Description of the Prior Art

In the recent years, the continuous improvement of the efficiency of the computer CPU system has speeded the public's reliance and need of the computer as well as driven the prosperous development of the whole electronic manufacturing. The industrials of various peripheral computer products have also continuously designed new multimedia in expectation of stimulating consuming and thereby promoted a good cycle of the market supply and demand.

In addition, after the research and innovation for many years, several kinds of computer CPU systems have been developed for different application ranges, such as a desktop portable computer suitable for the office setting, a notebook portable computer convenient for the personal carrying and usage, an industry portable computer or a personal digital assistant (PDA).

In order to facilitate the connection and communication between the mentioned various peripheral equipments and the computers, several communicating transmission protocol devices for the CPU have been developed, such as the regulations of 1394, the universal serial bus (USB), the infrared rays and the optical fiber, to enable the manufacturers of various peripheral equipments to design the interface for the computer system by following these regulations. It is only necessary to install the interfaces of the same transmission protocol device respectively on the peripheral equipments and the computer CPU systems to achieve the object of data transmission by means of a signal transmission cable. Among the communicating transmission protocol devices mentioned above, the 1394 and the USB devices are mostly preferred by all of the major manufacturers. The reasons are listed as follows:

1. The USB device:

The USB device has the advantages of having better connection, long distance transmission, plug and play as well as hot swapping. Through an USB device, the CPU end easily accomplishes the interface with the peripheral equipments, such as a scanner, a keyboard and a printer. Added by the full support from the major computer manufacturers, the USB regulation has even been more popular in many portable computers including both the desktop and notebook portable computers. Nowadays, the CPU providing the interfaces corresponding to the USB regulations, including USB 1.1 and USB 2.0, at the system ends has become the main trend in the market.

2. The 1394 device:

In 1995, the regulation interface of the 1394 device was recognized as the industrial standard by the Institute of Electrical and Electronics Engineers (IEEE). The transmission speed thereof is 400 Mb per second. To compare with the transmission speed of 12 Mb per second of the USB 1.1, the 1394 has extremely high transmission efficiency and more capability to satisfy those peripheral products with great amount of signal transmission, such as the image technical products of a scanner, a digital photographic machine and a digital camera. Therefore, most of the manufacturers of the computers and the peripheral products, in order to satisfy the user's daily increasing transmission demand, have started to develop products to support the 1394 device. Based on a report of a market research company, Cahners In-Stat, in the year of 2002, the 1394 device will become the embedded equipment in about 4,800,000 digital television sets (DTV, including decoders and set-top-boxes) and more than 40,000,000 items of other kinds of consuming electronic products will adopt the interface of the 1394 device. The industrials predict that the 1394 device will be the main trend of the future information products.

In addition to the mentioned communication protocols of the CPU systems, in order to correspond to the facilitation of the memory and transmission in independent use of the consuming electronic products of the computer peripheral products, such as the PDA, the DSC and the Mp3 Player, the computer peripheral equipments have also developed various memory storage media of different regulations, such as the PC card, the CF card, the SM (Smart Media) card, SD (Secure Digital) card, MS (Memory Stick) card, MMC (Multi Media) card and Micro Drive, wherein, the PC card and the CF card are the most extensively applied cards. Their usages have surpassed the simple memory function of the memory storage media and further developed several functions of communication and network. They are described as follows:

1. The storage communication network card of PC card regulation:

In 1993, the Personal Computer Memory Card International Association (PCMCIA) established the standard regulation for the computer memory card; those peripheral equipment products corresponding with this standard regulation are called in general as the PC card regulations. Since then, the PC card regulation has been extensively applied to various peripheral equipments for connecting the computers, especially the notebook computers. Since the design of the notebook computer is limited by the size of the CPU, various externally connected peripheral equipments are needed for supporting the application demand. The PC card with the advantages of having light weight and small volume has at least developed the memory card, the digital card, different types of the converter cards (or apparatuses) for the memory cards, the cabled and wireless network cards as well as the bluetooth card (wireless communication card) for different applications and that makes the PC card almost become the standard interface for all the notebook computers.

2. The storage communication network card of CF card regulation:

The CF card is developed in 1994 and is a memory card regulation of very light weight and small volume. It also has the special features of better data storage, high reliability and saving of electricity. Therefore, it is quiet preferred by the consuming electronic products. For the present, they are mostly used in the peripheral products of the Internet appliance (IA) products, such as the PDA, the DSC and the MP3 Player. They have also developed at least the memory card, the digital card, different types of the converter cards (or apparatuses) for the memory cards, the cabled and wireless network cards as well as the bluetooth card (wireless communication card). They are very convenient in use. Up to now, more than 100 manufacturers and more than 500 kinds of different products adopt CF card as their application regulation.

From the mentioned development of the PC card, the CF card and their application, it is not difficult to see that under a great amount of adoption of the consuming electronic products, the PC card and the CF card have been developed not just as simple memory cards, but formed as storage communication cards. Their application will be even more popular from now on. However, all of the mentioned storage communication network cards and the communication protocol devices belong to different systems and are not compatible and that caused the inconvenience in application. For example, when a user want to send an image file shot by a digital camera and stored on a CF card to a CPU system of a personal computer for storage, he has to additionally purchase a card reader interface of CF card exclusively for reading, then the interface of the USB or the 1394 communication protocol device on the card reader transmits the information to the interface of the computer CPU system to read. Therefore, the convenience in use of the storage communication network card is reduced.

To the computer manufacturers, along with the popularity of the various portable IA products, many peripheral equipments apply the regulations of storage communication network cards (PC card and CF card) to the domain of the application products in the aspect of communication, network and storage. Even the bluetooth card (wireless communication card) generated from the bluttooth technology forces the computer manufacturers to consider the necessity of disposing an insert slot on the computer CPU system of the new generation for the interface of the storage communication network card in order to adapt to the significantly increasing IA trend and the consumer's expectation. However, in doing so, the manufacturing cost of the computer CPU system will be increased. To the computer manufacturers with already slumped profit, it is a painful decision making.

In view of the mentioned many problems, how to strengthen the method of interface and connection of all the peripheral equipments corresponding with the storage communication network card regulations, how to strengthen the supporting model to eliminate the consumer's inconvenience in use and to overcome the difficulty of application and development in the future for the computer manufacturers have become the key points for the inventor to consider.

### SUMMARY OF THE INVENTION

The present invention relates to a double interfaced storage communication network card with a communication protocol device, the said storage communication network card has a peripheral product corresponding with the regulations of a PC card and a CF card; the communication protocol device of the USB or the 1394 regulation is disposed on the storage communication network card; a micro control chip automatically detects, judges and supports the interfaces of the said two kinds of devices to directly interface the central process unit (CPU) system without going through an intermediate products, such as a card reader, thereby significantly enhances the facilitation of interfacing and connecting between all of the peripheral equipment products corresponding with the storage communication network card regulation and the CPU system.

The primary object of the present invention is to utilize the double interfaced integral device with both the communicating transmission protocol interface and the storage communication network card interface to enable the storage communication network card to directly interface and connect the computer CPU system, without going through an intermediate product, thereby significantly enhances the facilitation of interfacing and connecting between all of the peripheral equipment products corresponding with the storage communication network card regulation and the CPU system; it is advantageous and helpful to the consumer's convenience in use, the adaptable range of the storage communication network card and the future development of the computer CPU system manufacturers for improving the efficiency.

To enable a further understanding of the contents of the present invention, the brief description of the drawings below is followed by the detailed description of the preferred embodiment.

### BRIEF DESCRIPTION OF THE DRAWINGS

FIG. 1 is an external view and pictorial drawing of the first exemplary embodiment of the present invention.

FIG. 2 is a partial and cross-sectional drawing of the first exemplary embodiment of the present invention.

FIG. 3 is an action flowchart of the present invention.

FIG. 4 is an external view and pictorial drawing of the second exemplary embodiment of the present invention.

FIG. 5 is a schematic drawing of the interface and connection between the present invention and a computer CPU system.

### DETAILED DESCRIPTION OF THE PREFERRED EMBODIMENTS

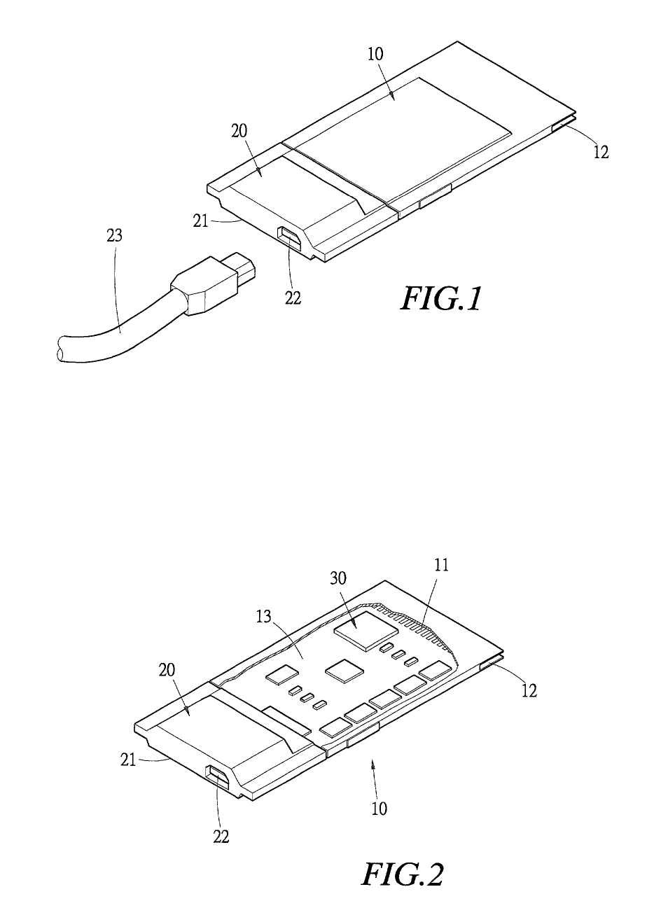

As shown in FIGS. 1 and 2, the present invention of a double interfaced storage communication network card with a communication protocol device is applied to a peripheral product corresponding with the regulation of a PC card (10); the said peripheral products includes at least the memory card, the digital card, various types of converter cards (or apparatuses) for the memory cards, the cabled and the wireless network cards as well as the bluetooth card (wireless communication card); the front end thereof has a first interface (11) and a first signal transmission end (12) to be inserted to the predetermined insert slot for PC card (10) interface on a notebook computer or a consuming electronic product (that is a known technique and will not be further described here) for supporting the application demand of the said notebook computer or the consuming electronic product.

The said PC card (10) having a receiving space inside for accommodating a circuit board (13), a chip, a memory body and other necessary electronic elements, is characterized that the relative end of the first interface (11) of the PC card (10) is disposed with a communication protocol device (20); the said communication protocol device (20) uses the USB or the 1394 device and it further includes a second interface (21) and a second signal transmission end (22), wherein the second transmission end (22) connects the signal transmission cable (23) for connecting the computer CPU system.

A micro control chip (30) is disposed on the circuit board (13) of the PC card (10); the said micro control chip (30) automatically detects, judges and supports the action signals of the first interface (11) and the second interface (21); when any one of the signal transmission ends (12, 22) of the first interface (11) or the second interface (21) provides action signals, the micro control chip (30) orders the circuit board (13) and other electronic elements of the PC card (10) to support the instructional action of the first or the second signal transmission ends (12, 22).

Through the mentioned technological features, when the first signal transmission end (12) of the first interface (11) of the PC card (10) is inserted to the notebook computer or other consuming electronic products, the micro control chip (30) automatically detects, judges and supports the signal of the instructional action of the first interface (11) to make the PC card (10), through the first interface (11), the first signal transmission end (12), the circuit board (13) and other electronic elements, to support the application demand and to conduct the function of the digital card, the area network card, the hard disk card or the memory card.

As the same, when the second signal transmission end (22) of the second interface (21) of the PC card (10) connects the computer CPU system by means of the signal transmission cable (23), the micro control chip (30) automatically detects, judges and supports the signal of the instructional action of the second interface (21) to make the PC card (10), through the second interface (21), the second signal transmission end (22), the circuit board (13) and other electronic elements, to support the application demand of the said computer CPU system and to conduct the function of the device of the USB or the 1394.

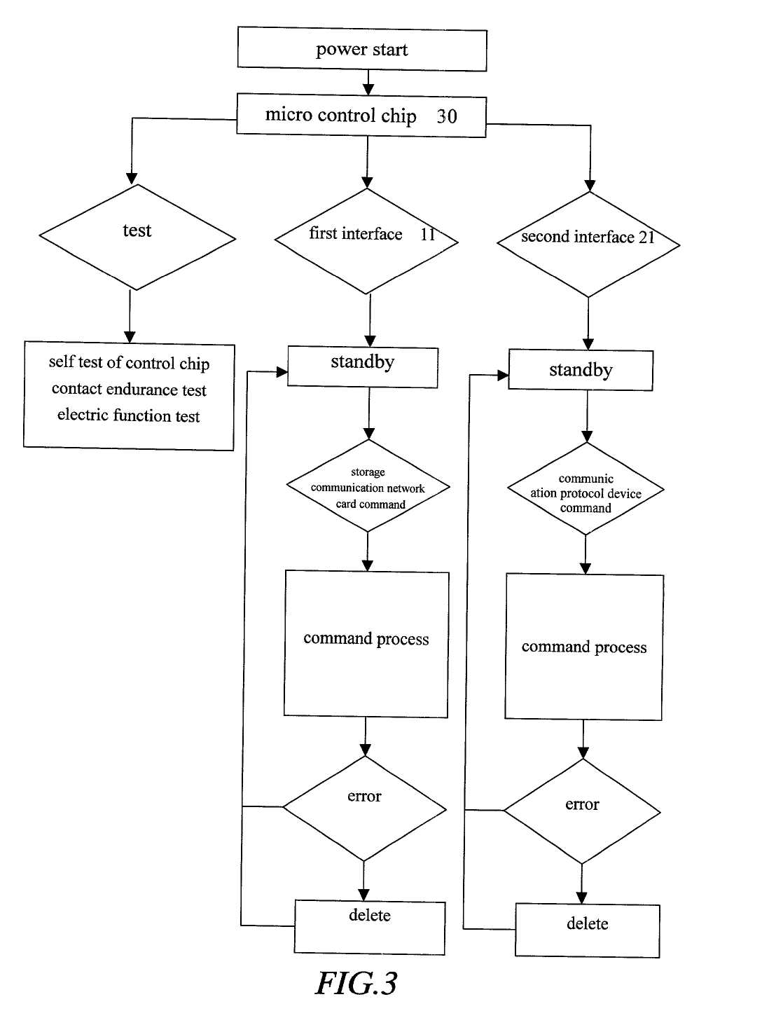

As shown in FIG. 3 of the action flowchart of the present invention, after the first or the second interface (11, 21) of the PC card is interfaced and activated, the power source needed for the action of the PC card is provided immediately; at this time, the micro control chip starts to work and detects whether the electric function of each electronic component and the connecting point on the said PC card is normal or not; at the same time, the micro control chip (30) also detects and judges if the power source is provided by the first or the second interface (11, 21) and makes the other electronic components to stand by for supporting the instruction ordered by the first or the second interface (11, 21); wherein the first interface (11) has the functional instruction of the storage communication network card (PC card) and the second interface (21) has the instruction of the communication protocol device (the USB or the 1394 device); the instruction will be processed after being received; if the instruction is wrong, it will be deleted and the stand-by state will be resumed.

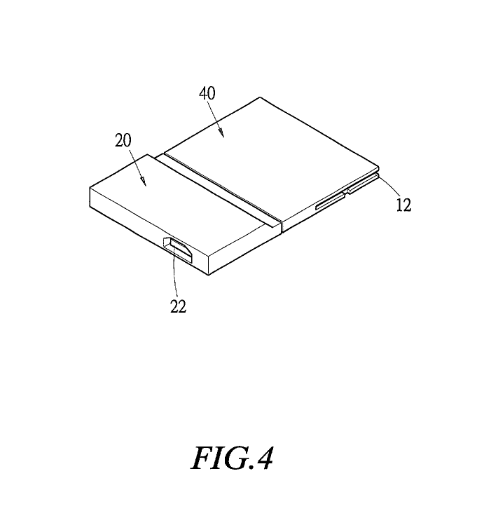

Referring to FIG. 4 of the exemplary embodiment of the present invention applied to a peripheral product corresponding with the regulation of a CF card (40); the peripheral products of the said CF card (40) regulation includes at least the memory card, the digital card, various types of converter cards (or apparatuses) for the memory cards, the cabled and the wireless network cards as well as the bluetooth card (wireless communication card); to compare with the exemplary embodiment of the PC card (10) in FIG. 2, only the external view is slightly different, all of the technology of the other components, function and operation flow are the same and they will not be further described here.

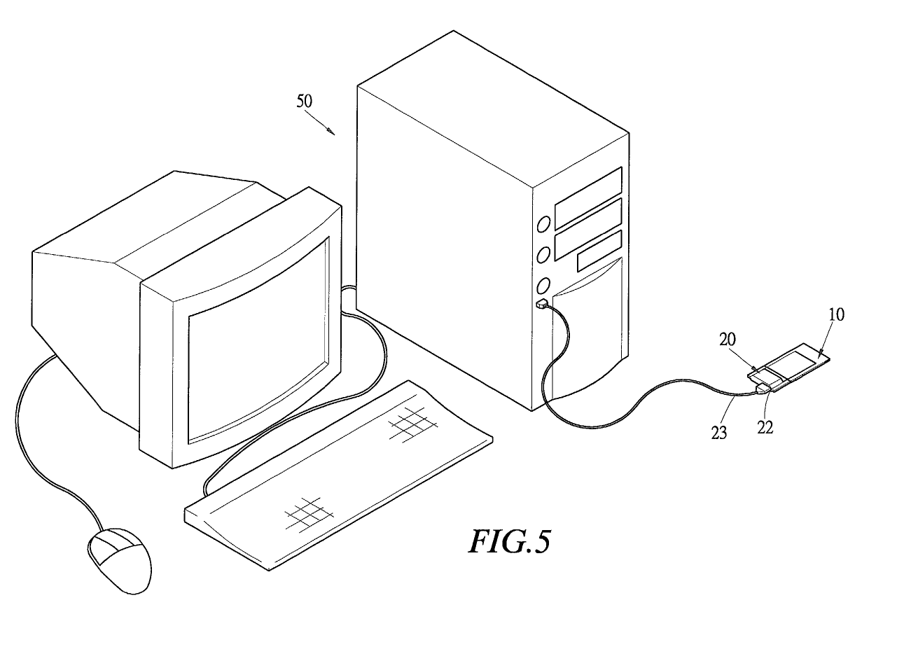

Referring to FIG. 5, as mentioned before, within the present invention of a double interfaced storage communication network card with a communication protocol device, the storage communication network card can be a PC card (10) or a CF card; the first signal transmission end of the first interface is inserted to the predetermined interface insert slot on the notebook computer or the consuming electronic products to support the application demand of the said notebook computer or the consuming electronic products. Except that, the communication protocol device disposed at the relative end of the first interface can be connected to the computer CPU system (50) through the second interface, the second signal transmission end (22) and the signal transmission cable (23).

In other words, by virtue of the technologic features of the present invention, the storage communication network card not only can be inserted to the insert slot of the notebook computer or the consuming electronic products, it also can directly interface the computer CPU system, without going through an intermediate product, such as a card reader; that significantly enhances the facilitation of the interface between all of the peripheral products corresponding with the regulation of the storage communication network card and the CPU system; it is advantageous and helpful for the consumer's convenience in use, the adaptable range of the storage communication network card and the future development of the computer CPU system manufacturers.

The terminology used for all of the said components and illustrations have been selected to facilitate the description of the technologic contents of the present invention and shall not be construed as a limitation on the patented scope and claims of the present invention; any substitution of components of equivalent effect based on the spirit of the present invention shall still be regarded as within the protected scope and claims of the new patent rights granted the present invention.

1. A double interfaced storage communication network card with a communication protocol device, a first interface and a first signal transmission end disposed at the front end thereof for inserting in the interface insert slot so as to support the application demand and a receiving space disposed inside for accommodating a circuit board, a chip and a memory body, is characterized that:
a communication protocol device is disposed at the relative end of the
first interface; the said communication protocol device further has a second interface and a second signal transmission end for connecting a computer CPU system; a micro control chip is disposed on the circuit board; the said micro control chip automatically detects, judges and supporting the action signals of the first and the second interfaces; when any of the signal transmission end of the first or the second interface provides action signals, the micro control chip orders the circuit board or other electronic components to support the instructional action of the first or the second signal transmission end.

2. A double interfaced storage communication network card with a communication protocol device according to claim 1, wherein the storage communication device includes at least a peripheral product corresponding with the regulations of the PC card and the CF card.

3. A double interfaced storage communication network card with a communication protocol device according to claim 1, wherein the communication device includes at least the USB and the 1394 devices.

4. A double interfaced storage communication network card with a communication protocol device according to claim 1, wherein the second signal transmission end connects the signal transmission cable for connecting the computer CPU system.

5. A double interfaced storage communication network card with a communication protocol device according to claim 2, wherein the peripheral products corresponding with the regulations of the PC card and the CF card includes at least the memory card, the digital card, various types of converter cards (or apparatuses) for the memory cards, the cabled and the wireless network cards as well as the bluetooth card (wireless communication card).
